(19) United States
(12) Patent Application Publication
(10) Pub. No.: US 2014/0160561 A1
(43) Pub. Date: Jun. 12, 2014

(54) ADJUSTING DEVICE ON AN OPTICAL INSTRUMENT

(71) Applicant: Carl Zeiss Sports Optics GmbH, Wetzlar (DE)

(72) Inventors: Armin Schlierbach, Leun-Bissenberg (DE); Dirk Luthardt, Wetzlar (DE); Sebastian Kulessa, Bovenden (DE)

(73) Assignee: Carl Zeiss Sports Optics GmbH, Wetzlar (DE)

(21) Appl. No.: 14/183,104

(22) Filed: Feb. 18, 2014

Related U.S. Application Data
(63) Continuation of application No. PCT/EP2012/064807, filed on Jul. 27, 2012.

(30) Foreign Application Priority Data
Aug. 18, 2011 (DE) 10 2011 110 991.2

(51) Int. Cl. G02B 23/00

(52) U.S. Cl. CPC G02B 23/00
USPC 359/425

(57) ABSTRACT

An adjusting device for linearly displacing an assembly has a rotary knob rotatable in first and second rotary directions. A gear unit rapidly displaces the assembly in a first linear direction when the rotary knob is rotated in the first rotary direction and slowly displaces the assembly in a second linear direction opposite the first linear direction when the rotary knob is rotated in the second rotary direction over a defined rotation angle.

### CROSS REFERENCE TO RELATED APPLICATIONS

This application is a continuation application of international patent application PCT/EP2012/064807, filed Jul. 27, 2012, designating the United States and claiming priority from German application 10 2011 110 991.2, filed Aug. 18, 2011, and the entire content of both applications is incorporated herein by reference.

### FIELD OF THE INVENTION

The invention relates to an adjusting device having a gear unit, which is drivable in opposite directions of rotation by way of a rotary knob, for displacing an assembly, in particular for the linear displacement of at least one focusing lens along an optical axis of an optical instrument. When the rotary knob is rotated in the first direction of rotation, rapid displacement of the assembly in a first direction is effected via the gear and when the rotary knob is rotated in the opposite direction of rotation for a defined angle of rotation the assembly is displaced slowly in an opposite direction.

### BACKGROUND OF THE INVENTION

In the case of optical instruments such as monocular or binocular telescopes, telescopic sights, microscopes or the like, an objective lens is usually arranged inside a barrel-shaped tube as well as an eyepiece, where applicable a reversal group and a further assembly in order to focus the optical instrument. A focusing lens, which is arranged so as to be displaceable in a linear manner along an optical axis of the optical instrument, usually serves for this purpose. Rotary knobs, which are to be operated by a user, are rotatable in opposite directions of rotation and via a gear bring about the linear displacement of at least one focusing lens, are provided, for example, in the case of a monocular or binocular field glass. Consequently, the optical instrument, such as a field glass, is able to be focused on different distances for the accurate viewing of an object. In the case of a binocular field glass, in particular the focusing lenses for the two beam paths are displaced together by means of a gear or a rotary knob.

U.S. Pat. No. 5,689,366 discloses an adjusting device for focusing a microscope where two rotary knobs are provided in order to make coarse and fine adjustments of the focusing possible. In the case of the coarse adjustment, a rotary movement of a first rotary knob is transmitted to a focusing lens by the gear at a relatively large transmission ratio such that a rotation of the first rotary knob about a certain angle of rotation brings about a relatively large travel and consequently a large change in the focusing of the microscope. A more accurate focusing of the microscope can be performed by way of a second rotary knob at a smaller transmission ratio as a rotation of the second rotary knob by the same angle of rotation only brings about a smaller displacement for example of a focusing lens along the optical axis as a result of the smaller transmission ratio.

DE 35 463 17 A1 discloses a coarse and fine adjustment for an optical instrument where, by means of one single rotary knob, a displacement of an assembly, in particular for the linear displacement of at least one focusing lens, can be carried out by means of a gear. In this case, a coarse adjustment with a large transmission ratio or large travel of the assembly can be carried out by means of the rotary knob when actuated by a certain angle of rotation in a first direction of rotation. If a focus point of the optical instrument is actually overshot, a displacement of the assembly, that is in particular of the focusing lens, at a smaller transmission ratio or a smaller travel can be carried out for exact focusing by means of the fine adjustment by rotating the single rotary knob in the opposite direction of rotation over the same angle of rotation. A temperature-dependent energy storing device, for example in the form of a thermostatic bimetal spring, is necessary as well as considerable structural expenditure such that, especially in the case of longer use, wear and tear or a considerable maintenance requirement cannot be ruled out.

### SUMMARY OF THE INVENTION

It is an object of the invention to improve an adjusting device for optical instruments of the type mentioned above to the effect that a coarse and fine adjustment can be carried out via one single rotary knob, wherein the complexity of structure for a gear unit for converting a rotary movement of the rotary knob into a linear displacement of the unit is reduced.

In the case of the adjusting device according to the invention, the rotary knob is connected in a non-rotatable manner to an articulated shaft which, in turn, is mounted so as to be rotatable but fixed in position, for example in a barrel-shaped housing of an optical instrument. The articulated shaft can also be designated as a gear shaft. A first external thread, which has a first large pitch, is realized, at least in portions, on the articulated shaft on the outside of the circumference thereof. This external thread interacts with a driving nut which, in turn, has a first internal thread which corresponds to the first external thread. The driving nut, in turn, is positively guided in such a manner that it is not able to co-rotate with the articulated shaft for example as a result of frictional forces. This means that a rotating of the rotary knob or of the articulated shaft results in a linear displacement of the driving nut along the axial extension of the articulated shaft. Depending on the direction of rotation of the rotary knob, that is, of the articulated shaft, the driving nut is displaced in a linear direction toward the rotary knob or in the opposite direction. This is brought about as a result of at least one protruding arm, which interacts with a linear guide on an inner surface, for example, on the barrel-shaped housing of the optical instrument, being realized on the driving nut. If the articulated shaft were rotated, a non-supported driving nut would co-rotate with the articulated shaft; since, however, the protruding arm is guided in a linear guide which extends parallel to the axial extension of the articulated shaft, the driving nut is forcibly displaced along the axial extension of the articulated shaft.

A second external thread, which has a second pitch which is smaller than the first large pitch, is realized, in turn, on the outside of the driving nut at least in portions on the circumference thereof. This second external thread on the driving nut, in turn, interacts with a driving piece which is rotatable in relation to the driving nut and, for this purpose, has a second internal thread which corresponds to the second external thread on the driving nut. In this case, the pitches of the differently steep threads or the respective coefficients of static friction and coefficients of sliding friction between the above-described components are chosen in such a manner that, in a first direction of rotation, the driving piece always co-rotates together with the driving nut in a first direction of rotation, that is, is not displaced in relation thereto. In addition, a stop segment, which is recessed over a defined angle of rotation, is present on the driving piece in the first direction of rotation and entrains the driving piece together with the driving nut, is realized on the driving nut.

A radially outwardly pointing double lever, which interacts with a stop of a focusing rod which extends parallel to the longitudinal axis of the articulated shaft or engages around, for example, a circumferential shoulder on the stop of the focusing rod, is realized, for example, on the driving piece. Consequently, the rotating of the rotary knob in a first direction of rotation by means of the axial displacement of the driving nut, and equally the corresponding axial displacement of the driving piece, brings about an axial displacement of the focusing rod. For example, a focusing holder for a focusing lens is arranged, in turn, on the focusing rod such that by rotating the rotary knob in a first direction of rotation by means of the focusing rod, the focusing lens is displaceable in the linear direction preferably along the optical axis of the optical instrument in order to obtain optical focusing on a desired distance.

In this case, the above-described gear unit is realized in such a manner that when the rotary knob is rotated in the first direction of rotation, a so-called coarse adjustment is effected. This means that a slight rotation of the rotary knob results in a large travel or a relatively rapid or strong axial displacement of the focusing lens, for example 1 mm travel in the case of rotation of the rotary knob by 1°. However, if the exact focus point of the optical instrument has actually just been overshot by means of the coarse adjustment, this can be perceived visually by a user and the further rotation in the first direction of rotation can be terminated. The rotary knob is then actuated in the opposite second direction of rotation. This results in an opposite axial displacement of the driving nut.

As, however, the stop segment, which is recessed over a defined angle of rotation, is realized on the driving nut, the driving piece is then no longer driven or entrained directly by the driving nut. The driving piece, in turn, is fixed in the circumferential direction, however, by the afore-described double lever because of the stop of the focusing rod, corresponding, as described above, to the driving nut in a linear guide such that the driving piece does not co-rotate in relation to the driving nut, but, as a result of the smaller pitch of the second external thread of the driving nut and of the second internal thread of the driving piece, rotates at a smaller pitch in relation to the driving nut. In this case, the focusing rod is displaced axially in the opposite direction to the afore-described coarse adjustment. In this case, however, only a smaller travel or only a relatively slow or small axial displacement is generated at an identical angle of rotation as a result of the smaller thread pitch. For example, a rotation about 120° can mean only a travel of 1 cm such that a fine adjustment is realized in order to be able to focus the focusing lens exactly in the opposite linear direction of movement.

The stop segment, in this case, is realized in such a manner that it is recessed over the defined angle of rotation; this means that when the rotary knob is rotated up to the defined angle of rotation, a fine adjustment is effected. The driving piece is then present, in turn, on the stop segment of the driving nut and is entrained by the driving nut over the greater pitch of the first external thread, in turn, at an enlarged travel.

In this case, the pitch ratios of the respective threads are chosen in such a manner that a desired ratio for coarse and fine adjustment in relation to one another is obtained. The materials of the individual components can also be chosen in such a manner that in particular when the fine adjustment is rotated back in the second direction of rotation, the driving piece rotates at a relatively small resistance in relation to the driving nut. In particular, a combination of materials can be chosen in such a manner that the afore-described functionality is safeguarded even at different environmental temperatures.

An advantage of the invention is that only a few components are required in order to obtain a coarse and fine adjustment with variable travel at the identical angle of rotation such that, in particular, practically no expenditure on maintenance is necessary and mechanical damage is practically excluded as a result of purely rotating or linearly moving components.

For developing the optical instrument, it is proposed that it is a monocular or binocular field glass, that is colloquially a spotting scope or a field glass. In this connection, by combining the coarse and fine adjustment in one single rotary knob, the operability is made considerably easier. For example, a binocular field glass can be held in only one hand and focused at the same time. In this case, the focusing lenses in the two tubes are driven by one common gear. The optical instrument can also be a microscope, for example.

To choose the defined angle of rotation, it is proposed that the angle is 120 degrees or ⅓ of a circle. A sufficient travel for a fine adjustment, which is usually carried out relatively slowly and consequently so as to be exactly adjustable, is provided by way of the angle selection. In principle, however, other arbitrary angles of rotation can be selected, for example 90 degrees, 150 degrees, 180 degrees or any arbitrary angle in between. Using one or several trailing disks, a defined angle of rotation in excess of 360° can also be realized.

In order to ensure the rotation of the driving piece in relation to the driving nut and of the driving nut in relation to the articulated shaft, in particular in the case of the second opposite direction of rotation for fine adjustment, the expert is able to select not only different material combinations for the different threads as described above, but also different lubricants can be used in order, for example, to ensure that less adhesive friction and/or sliding friction forces exist between the driving piece and the driving nut than between the driving nut and the articulated shaft.

Different materials are preferably used for the individual components and/or threads. This can be realized, for example, in such a manner that the driving nut and the driving piece are plastics material components and the respective other component is realized from a metal material. This also includes, in principle, only the threads themselves being realized in different materials. For example, the driving piece is a metal component with an external thread of plastics material or vice versa.

In addition, an O-ring seal, for example of a silicone material, can be arranged on the articulated shaft between the rotary knob and the driving nut in order to act additionally as an entrainment means for the driving nut.

### BRIEF DESCRIPTION OF THE DRAWINGS

The invention will now be described with reference to the drawings wherein:

FIG. 1 shows a side view of a step drive;

FIG. 2 is a detail view of an arm (as viewed in the direction of arrow II in FIG. 1) of the driving nut extending into a linear guide of an optical instrument; and,

FIG. 3 shows a top view of a step drive.

### DESCRIPTION OF THE PREFERRED EMBODIMENTS OF THE INVENTION

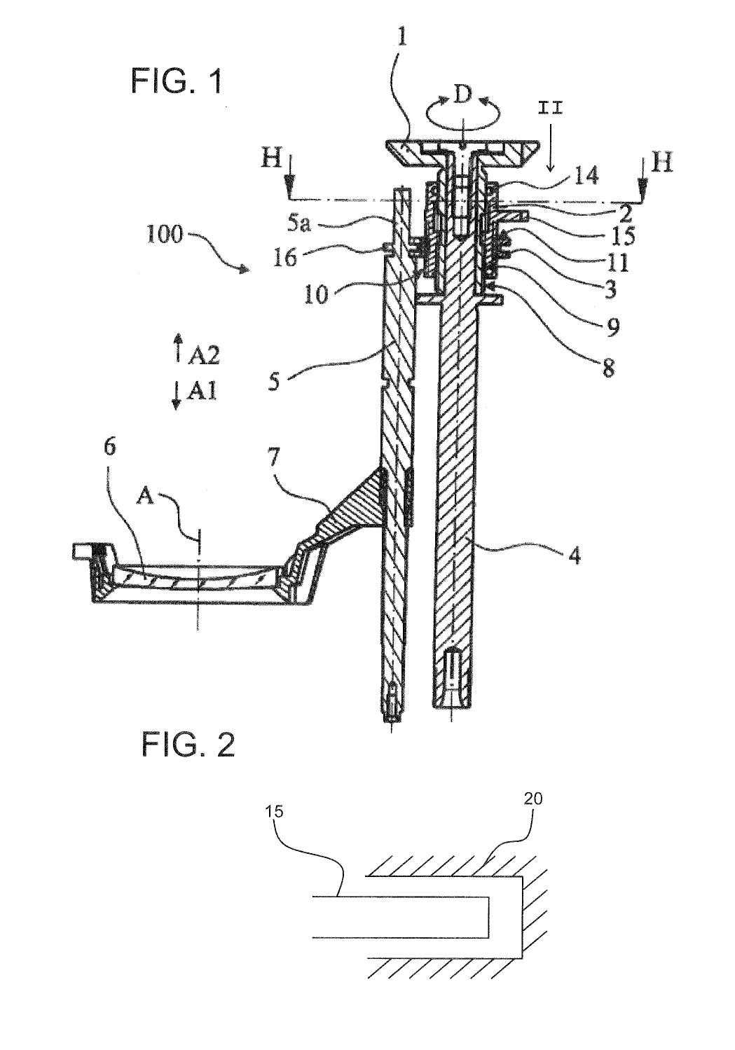

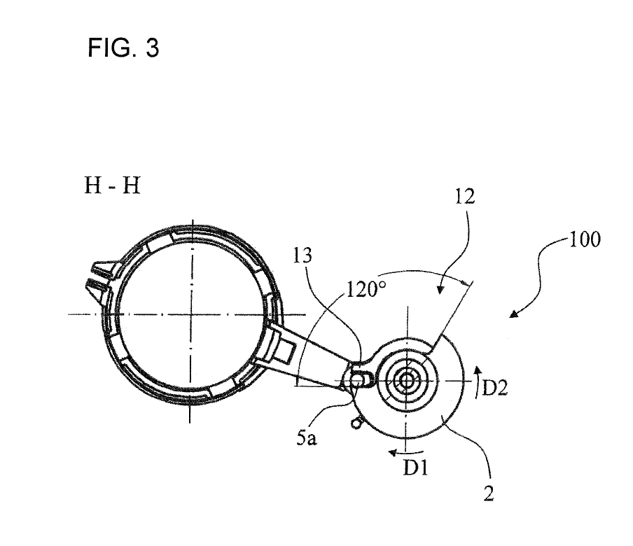

FIG. 1 shows a side view of an adjusting device 100 and FIG. 3 shows a top view of the adjusting device along the dot-dash line H-H in FIG. 1. The adjusting device 100 for an optical instrument such as, for example, a monocular or binocular field glass, a microscope or the like includes a gear which is assembled from several components.

A rotary knob 1 is rotatable in opposite directions, as can be seen by the double arrow D or the direction of rotation arrows D1 and D2 in FIG. 3. The rotary knob 1 is connected in a non-rotatable manner to an articulated shaft 4 and/or is integrally realized with the articulated shaft, which, in turn, is preferably mounted so as to be rotatable but fixed in position in a barrel-shaped tube of an optical instrument (not shown here so as to simplify the representation). A first external thread 8 with a first large pitch is realized at least in portions on the outer surface of the articulated shaft 4. A driving nut 2 is mounted on the first external thread 8 so as to be rotatable in relation to the articulated shaft 4. If the rotary knob 1, and consequently the articulated shaft 4, were rotated, the driving nut 2 would initially co-rotate with the articulated shaft 4. The driving nut 2, however, is realized in such a manner that there is provided, for example, a protruding arm 15 which is guided in a linear guide preferably parallel to the optical axis A of the optical instrument such that the rotary movement D of the rotary knob 1, that is, of the articulated shaft 4 is converted into a linear displacement (A1, A2) as indicated by the arrows. FIG. 2 is a detail view which shows the arm 15 disposed in a linear guide 20 of the optical instrument. In this case, an axial displacement is effected in the direction (A1, A2) or in reverse depending on the direction of rotation (D1, D2).

A first internal thread 9 which corresponds to the first external thread 8 is realized with the identical pitch on the driving nut 2 for this purpose. A second external thread 10 is realized, in turn, on the outside of the driving nut 2, at least in portions on the circumference thereof, with a second pitch which is smaller than the first large pitch of the first external thread 8. A driving piece 3 is mounted, in turn, on the second external thread 10 so as to be rotatable in relation to the driving nut 2, the driving piece 3 being provided with a second internal thread 11, which corresponds to the second external thread 10, having the second smaller pitch. The driving piece 3 has a double lever 13 or entrainment means, as shown in FIG. 3, which points radially outward and interacts with a stop 5a which is described below.

A focusing lens 6, which is linearly displaceable along an optical axis A in the direction (A1, A2), serves for optically focusing the optical instrument. The focusing lens 6 is mounted, for example, in a focusing holder 7 which, in turn, is axially displaceable by means of a focusing rod 5. A stop 5a, which extends in a linear manner parallel to the optical axis A, is realized on the focusing rod 5. A circumferential shoulder 16, which interacts with the double lever 13, is realized on the stop 5a. In this case, the focusing rod 5 is mounted in such a manner, for example in a tubular-shaped housing of the optical instrument, that it is displaceable parallel to the optical axis A.

If the rotary knob 1 is then rotated, for example, in the first direction of rotation D1, the driving nut 2 is displaced as a result of the linear guiding by the protruding arm 15 in the axial direction for example in the direction A1 in relation to the articulated shaft 4. In this case, the driving piece 3 as well as, accordingly, by means of the double lever 13 and the circumferential shoulder 16, the stop 5a, that is, the focusing rod 5 is entrained in the identical axial direction A1. For this purpose, the pitch of the first external thread 8 is preferably realized in such a manner that a large travel is achieved, which signifies a coarse adjustment, where a small rotation D1 of the rotary knob 1 results in a large axial displacement for example A1 of the focusing rod 5, that is, of the focusing lens 6.

If then the focus point of the optical instrument is “overshot” as it were, the rotary movement in the first direction of rotation D1 of the rotary knob 1 is terminated by the user and the rotary knob 1 is then rotated back in the opposite direction D2. In this case, a stop segment 12, which is recessed over a defined angle of rotation, for example 120°, is provided on the driving nut 2. This means that over the defined angle of rotation, the driving nut 2 is not present on the stop 5a of the focusing rod 5 and consequently a relative movement between the stop 5a, that is, the driving piece 3 and the driving nut 2 is made possible. In this case, the pitch of the second external thread 10 on the driving nut 2, that is, of the second internal thread 11 on the driving piece 3 is smaller than the first larger pitch. Consequently, the driving piece 3 is displaced in the opposite axial direction A2 in relation to the driving nut 2, a smaller travel being realized at the identical angle of rotation on account of the smaller pitch of the second external thread 10. Consequently, a fine adjustment of the optical instrument, that is, of the focusing lens 6 is achieved. If the driving nut 2 is rotated in the second, opposite direction of rotation D2 so far that the stop segment 12 is completely used up and the driving nut 2 is once again present on the stop 5a of the focusing rod 5, the driving piece 3 is, once again, entrained and a new larger travel or a coarse adjustment is effected.

The materials of the individual components of the gear of the adjusting device 100 can be chosen in any desired manner by the expert, for example combinations from different metal and/or plastics materials are conceivable. It is also possible to provide different lubricants in order to obtain the corresponding desired coefficients of static friction and/or sliding friction of the different threads even over large temperature ranges such that the afore-described coarse and fine adjustment is made possible. In addition, an O-ring seal 14, for example of silicone, can be provided in order to operate as an additional entrainment means for the driving nut 2.

It is understood that the foregoing description is that of the preferred embodiments of the invention and that various changes and modifications may be made thereto without departing from the spirit and scope of the invention as defined in the appended claims.

### LIST OF REFERENCES

1 Rotary knob
2 Driving nut
3 Driving piece
4 Articulated shaft
5 Focusing rod
5a Stop of the focusing rod
6 Focusing lens
7 Focusing holder
8 First external thread
9 First internal thread
10 Second external thread
11 Second internal thread
12 Stop segment
13 Double lever
14 O-ring seal
15 Protruding arm
16 Circumferential shoulder
100 Adjusting device
D Direction of rotation
D1 First direction of rotation
D2 Second direction of rotation
A Optical axis
A1 First linear displacement
A2 Second linear displacement

What is claimed is:

1. An adjusting device for linearly displacing an assembly, the adjusting device comprising:
a rotary knob configured to be rotated in a first rotary direction (D1) and a second rotary direction (D2);
a gear unit configured to displace the assembly and to be drivable via said rotary knob in a first direction (A1) and a second direction (A2) opposite said first direction (A1);
said gear unit further being configured to rapidly displace said assembly in said first direction (A1) when said rotary knob is rotated in said first rotary direction (D1) and to slowly displace said assembly in said second direction (A2) when said rotary knob is rotated in said second rotary direction (D2) over a defined rotation angle;
said gear unit including an articulated shaft defining an exterior and having, at least in sections, a first outer thread on said exterior;
said first outer thread having a first pitch;
said rotary knob being connected to said articulated shaft so as not to be rotatable relative thereto;
a driving nut having a first inner thread corresponding to said first outer thread and being arranged on said first outer thread in a rotatable manner via said first inner thread;
said driving nut further having, at least in sections, a second outer thread having a second pitch which is less than said first pitch;
said gear unit further including a driving element having a second inner thread corresponding to said second outer thread and being rotatably arranged on said second outer thread;
a tappet rod connected to said assembly;
said tappet rod and said driving element conjointly defining an interface;
an entrainment unit arranged at said interface for coupling said tappet rod to said driving element so as to cause a linear displacement (A1, A2) of said tappet rod in response to a movement of said driving element;
said tappet rod having a linearly extending stop; and,
a stop segment formed on said driving nut as a cutout extending over a defined angle of rotation.

2. The adjusting device of claim 1, wherein said assembly includes at least one focusing lens, and said gear unit is configured to linearly displace said focusing lens along an optical axis of an optical device.

3. The adjusting device of claim 2, wherein the optical device is one of a monocular or binocular telescope.

4. The adjusting device of claim 1, wherein said defined angle of rotation is 120°.

5. The adjusting device of claim 1 further comprising lubricant disposed on said first and second inner threads and said first and second outer threads.

6. The adjusting device of claim 5, wherein different lubricants are disposed on said first and second inner threads and said first and second outer threads.

7. The adjusting device of claim 1, wherein said first and second inner threads and said first and second outer threads are made of materials having at least one of different static friction coefficients and different sliding friction coefficient.

8. The adjusting device of claim 1 further comprising an O-ring.

9. An optical apparatus defining an optical axis and comprising:
a focusing lens;
an adjusting device for linearly displacing said focusing lens along said optical axis; and,
said adjusting device including:
a rotary knob configured to be rotated in a first rotary direction (D1) and a second rotary direction (D2);
a gear unit configured to displace said focusing lens and to be drivable via said rotary knob in a first direction (A1) and a second direction (A2) opposite said first direction (A1);
said gear unit further being configured to rapidly displace said focusing lens in said first direction (A1) when said rotary knob is rotated in said first rotary direction (D1) and to slowly displace said focusing lens in said second direction (A2) when said rotary knob is rotated in said second rotary direction (D2) over a defined rotation angle;
said gear unit including an articulated shaft defining an exterior and having, at least in sections, a first outer thread on said exterior;
said first outer thread having a first pitch;
said rotary knob being connected to said articulated shaft so as not to be rotatable relative thereto;
a driving nut having a first inner thread corresponding to said first outer thread and being arranged on said first outer thread in a rotatable manner via said first inner thread;
said driving nut further having, at least in sections, a second outer thread having a second pitch which is less than said first pitch;
said gear unit further including a driving element having a second inner thread corresponding to said second outer thread and being rotatably arranged on said second outer thread;
a tappet rod connected to said focusing lens;
said tappet rod and said driving element conjointly defining an interface;
an entrainment unit arranged at said interface for coupling said tappet rod to said driving element so as to cause a linear displacement (A1, A2) of said tappet rod in response to a movement of said driving element;
said tappet rod having a linearly extending stop; and,
a stop segment formed on said driving nut as a cutout extending over a defined angle of rotation.

10. The optical apparatus of claim 9, wherein the optical device is one of a monocular or binocular telescope.

11. The optical apparatus of claim 9, wherein said defined angle of rotation is 120°.

12. The optical apparatus of claim 9 further comprising lubricant disposed on said first and second inner threads and said first and second outer threads.

13. The optical apparatus of claim 12, wherein different lubricants are disposed on said first and second inner threads and said first and second outer threads.
